(19) United States
(12) Patent Application Publication
(10) Pub. No.: US 2007/0121283 A1
(43) Pub. Date: May 31, 2007

(54) DO IT YOURSELF SERVER MODULES

(75) Inventors: Hsiu-Chang Lai, TU CHENG (TW); Ke Sun, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., TU CHENG (TW)

(21) Appl. No.: 11/308,743

(22) Filed: Apr. 28, 2006

(30) Foreign Application Priority Data
Nov. 25, 2005 (CN) 200510101788.6

(51) Int. Cl. G06F 1/16

(52) U.S. Cl. 361/683

(57) ABSTRACT

A server includes a front module (10), a middle module (50), and a back module (30). The front module includes a first chassis (12) able to receive a plurality of data processing components. The back module includes a second chassis (32) able to receive a plurality of auxiliary components to serve the data processing components via the middle module. Two first rails (18) are mounted to opposite sides of the first chassis of the front module respectively, for slidably engaging with a rack. Two second rails (34) are mounted to opposite sides of the second chassis of the back module, for slidably engaging with the rack.

### FIELD OF THE INVENTION

The present invention relates to a server, and particularly to server modules suitable for do it yourself (DIY) server assembly and repair.

### DESCRIPTION OF RELATED ART

Conventionally, a server includes a base dock, and an upper lid. The base dock has an upper beam bridging two opposite ends thereof. One end of the base dock is for mounting a plurality of data processing components, such as circuit boards, hard disk drives, and so on. The other end of the base dock is for mounting a plurality of auxiliary components, such as power supplies, fans, network switches, and so on. The upper lid is mounted to the base dock to enclose the data processing components and the auxiliary components. Sometimes, the data processing components or the auxiliary components may wear out. Worn out components should be repaired. However, some worn out components cannot be repaired. Thus, a new server should be bought to replace the above-mentioned server, which would be expensive.

Do it yourself (DIY) computer assembly is currently popular because DIY computer modules can be assembled to form a computer which is according to a user's taste. If some component of a module should wear out and cannot be repaired, the user need only replace that module, which is much less expensive than replacing the whole computer. Additionally, people enjoy a sense of achievement having assembled a computer. This option, however, is not available yet with servers for people who enjoy DIY projects.

What is desired, therefore, is server composed of modules suitable for people who would enjoy to do it for themselves.

### SUMMARY OF THE INVENTION

An exemplary server includes a front module, a middle module, and a back module. The front module includes a first chassis able to receive a plurality of data processing components. The back module includes a second chassis able to receive a plurality of auxiliary components to serve the data processing components via the middle module. Two first-rails are mounted to opposite sides of the first chassis of the front module respectively, for slidably engaging with a rack. Two second-rails are mounted to opposite sides of the second chassis of the back module, for slidably engaging with the rack.

Other advantages and novel features will become more apparent from the following detailed description when taken in conjunction with the accompanying drawings, in which:

### BRIEF DESCRIPTION OF THE DRAWINGS

FIG. 1 is an exploded, isometric view of a server in accordance with a preferred embodiment of the present invention, the server includes a front module, a middle module, and a back module;

FIG. 2 is similar to FIG. 1, together with a rack;

FIG. 3 is similar to FIG. 2, showing the front module, the middle module and the back module being mounted to the rack; and

FIG. 4 is an assembled view of FIG. 2.

### DETAILED DESCRIPTION OF THE INVENTION

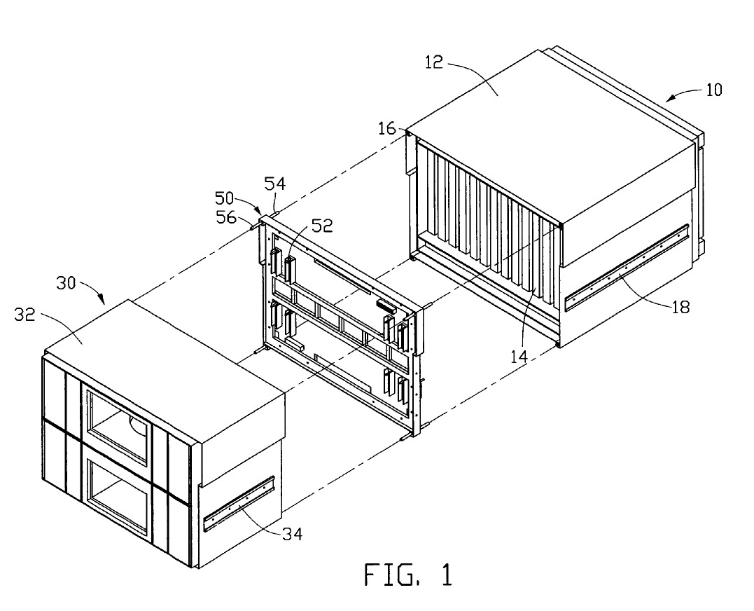

Referring to FIG. 1, a server in accordance with a preferred embodiment of the present invention includes a front module 10, a back module 30, and a middle module 50.

The front module 10 includes a chassis 12. A plurality of data processing components (not shown), such as circuit boards, hard disk drives, and so on, is mountable to the chassis 12. Ports 14 electrically connected to the data processing components are exposed on a rear surface of the front module 10. Two rails 18 are mounted to opposite sides of the chassis 12 respectively. A mounting hole 16 is defined in the chassis 12 at each corner thereof.

The back module 30 includes a chassis 32. A plurality of auxiliary components (not shown), such as power supplies, fans, network switches, and so on, is mountable to the chassis 32. Ports (not shown) electrically connected to the auxiliary components are exposed on a front surface of the back module 30. Two rails 34 are mounted to opposite sides of the chassis 32 respectively. A mounting hole (not shown) is defined in the chassis 32 at each corner thereof.

The auxiliary components of the back module 30 serve the data processing components of the front module 10 via the middle module 50. The middle module 50 includes a plurality of ports (not shown) at a front surface thereof, and a plurality of ports 52 at a rear surface thereof. Four posts 54 extend forward from four corners of the front surface of the middle module 50 respectively. Four posts 56 extend rearward from four corners of the rear surface of the middle module 50 respectively.

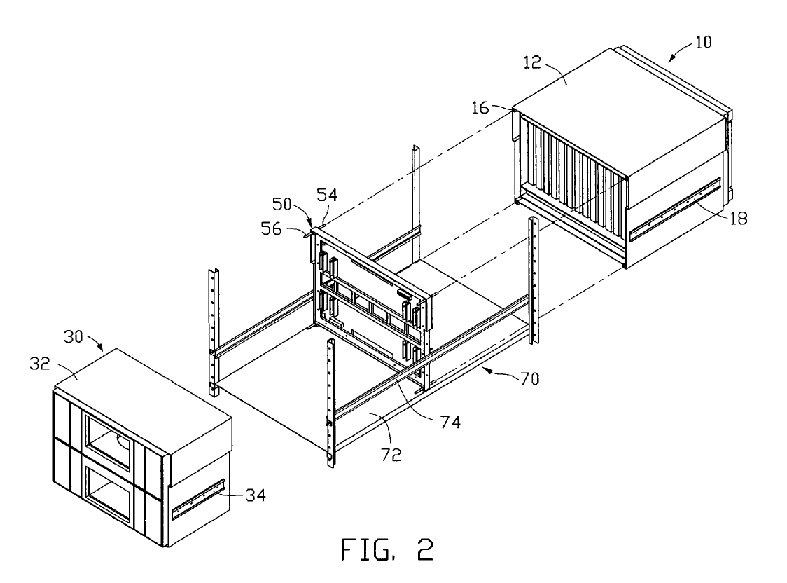

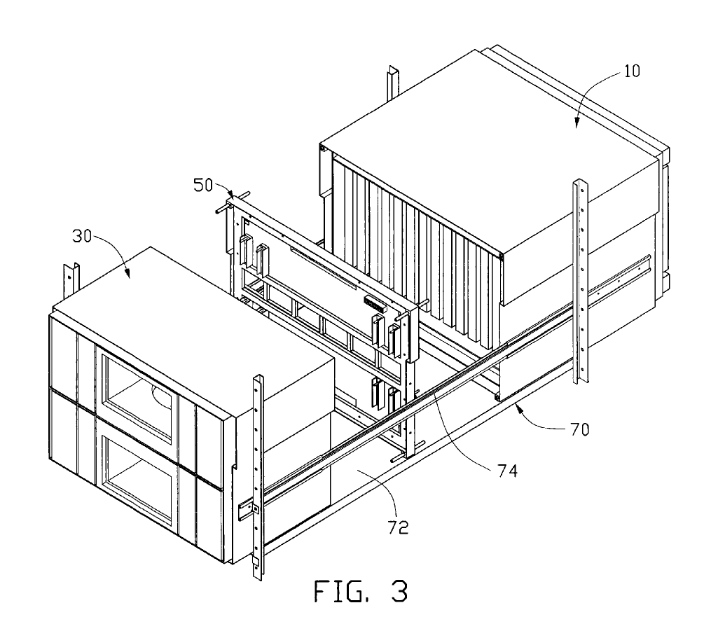

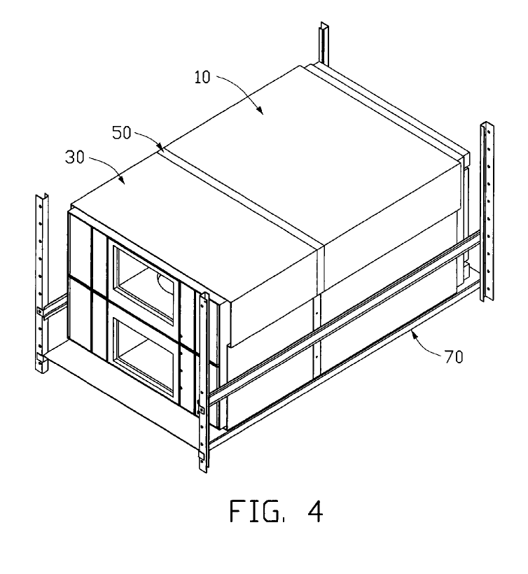

Referring also to FIGS. 2 to 4, in assembling the server to a rack 70, a bottom of the middle module 50 is supported on a supporting wall 72 of the rack 70. Two parallel rails 74 of the rack 70 clamp to opposite sides of the middle module 50 respectively. The front module 10 is placed on the supporting wall 72 of the rack 70. Each rail 18 of the front module 10 is slidingly engaged with the corresponding rail 74 of the rack 70 from one end facing the front surface of the middle module 50. The front module 10 is pushed to move toward the middle module 50. The posts 54 of the middle module 50 are engaged in the corresponding mounting holes 16 of the front module 10. Ports at the front surface of the middle module 50 are electrically connected to the ports 14 of the front module 10. Thus, the front module 10 is mounted to the middle module 50. The back module 30 is placed on the supporting wall 72 of the rack 70 from an opposite end facing the rear surface of the middle module 50. Each rail 34 of the back module 30 is slidingly engaged with the corresponding rail 74 of the rack 70. The back module 30 is pushed to move toward the middle module 50. The posts 56 of the middle module 50 are engaged in the corresponding mounting holes of the back module 30. Ports 52 at the front surface of the middle module 50 are electrically connected to the ports of the back module 30. Thus, the back module 30 is mounted to the middle module 50.

The server can be broken down into separate modules for convenient packing and transportation. Additionally, the modular design allows convenient repair, replacement, or upgrading of a part of a server rather than the great expense of replacing the whole server. Moreover, users can select the modules to assemble a server according to their individual taste and needs.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment of the invention.

What is claimed is:

1. A server comprising:
a front module comprising a first chassis able to receive a plurality of data processing components mounted thereon;
a middle module; and
a back module comprising a second chassis able to receive a plurality of auxiliary components to serve the data processing components via the middle module.

2. The server as claimed in claim 1, wherein the front module comprises a plurality of first ports exposed on a rear surface thereof, the middle module comprises a plurality of second ports arranged at a front surface thereof for electrically connecting with the corresponding first ports of the front module.

3. The server as claimed in claim 2, wherein the middle module further comprises a plurality of third ports arranged at a rear surface thereof, the back module comprises a plurality of fourth ports exposed on a front surface thereof for electrically connecting with the corresponding third ports of the middle module.

4. The server as claimed in claim 1, wherein four first mounting holes are defined in four corners of a rear side of the first chassis respectively, four first posts respectively extend from four corners of a front surface of the middle module to engage with the corresponding mounting holes of the front module.

5. The server as claimed in claim 1, wherein two first rails are mounted to opposite sides of the first chassis of the front module respectively, for slidably engaging with a rack.

6. The server as claimed in claim 1, wherein two second rails are mounted to opposite sides of the second chassis of the back module, for slidably engaging with a rack.

7. A server comprising
a front module comprising a first chassis for receiving a plurality of data processing components mounted thereon;
a middle module; and
a back module comprising a plurality of auxiliary components electrically connected to the middle module to serve the data processing components.

8. The server as claimed in claim 7, wherein the front module comprises a plurality of first ports exposed on a rear surface thereof, the middle module comprises a plurality of second ports arranged at a front surface thereof for electrically connecting with the corresponding first ports of the front module.

9. The server as claimed in claim 7, wherein two first rails are mounted to opposite sides of the first chassis of the front module respectively, for slidably engaging with a rack.

10. The server as claimed in claim 9, wherein two second rails are mounted to opposite sides of the second chassis of the back module, for slidably engaging with the rack.
